(19) United States
(12) Patent Application Publication
(10) Pub. No.: US 2003/0213300 A1
(43) Pub. Date: Nov. 20, 2003

(54) Sensor tube for determining a concentration profile

(76) Inventor: Peter Jax, Erlangen (DE)

Correspondence Address: LERNER AND GREENBERG, P.A., POST OFFICE BOX 2480, HOLLYWOOD, FL, 33022-2480, US

(21) Appl. No.: 10/461,817

(22) Filed: Jun. 6, 2003

Related U.S. Application Data
(63) Continuation of application No. PCT/EP01/14308, filed on Dec. 6, 2001.

(30) Foreign Application Priority Data
Dec. 6, 2000 (DE) 100 60 853.1

(51) Int. Cl. G01N 7/00

(52) U.S. Cl. 73/432.1

(57) ABSTRACT

A sensor tube for determining a concentration profile of a substance along a certain distance. The invention provides that an outer, hard, pressure-resistant tube is lined on the inside by a diffusion layer which is permeable to the substance. Holes extending from outside to the diffusion layer are arranged in the outer tube.

### CROSS-REFERENCE TO RELATED APPLICATION

This application is a continuation of copending International Application No. PCT/EP01/14308, filed Dec. 6, 2001, which designated the United States and which was not published in English.

### BACKGROUND OF THE INVENTION

### FIELD OF THE INVENTION

The invention relates to a sensor tube for determining a concentration profile of a substance along a given path. Such a sensor tube is known from U.S. Pat. No. 4,735,095 and European patent EP 0 175 219 B1. The sensor tube serves for detecting and localizing leaks. For this purpose, the sensor tube is laid, for example, along a pipeline. By way of the method described in U.S. Pat. No. 3,977,233 and German patent DE 24 31 907 C3, the location at which a detectable substance has emerged from the pipeline is determined. To be precise, this substance penetrates into the sensor tube and is subsequently delivered, with a pump that is connected to the sensor tube, to a sensor that is likewise connected to the sensor tube. By means of the known flow velocity, the leakage location on the pipeline can be determined from the timespan between the switch-on of the pump and the arrival at the substance of the sensor.

With the prior art device, leakage monitoring is possible only over distances of approximately 15 km (˜9 miles). Moreover, the known sensor tube may not withstand a very high external pressure. However, such a high external pressure occurs if the sensor tube is to be used for monitoring an underwater pipeline.

### SUMMARY OF THE INVENTION

It is accordingly an object of the invention to provide a sensor tube for determining a concentration profile which overcomes the above-mentioned disadvantages of the heretofore-known devices and methods of this general type and which sensor tube can be used over large line segments and, furthermore, also withstands a high external pressure.

With the foregoing and other objects in view there is provided, in accordance with the invention, a sensor tube for determining a concentration profile of a substance along a path, comprising:

a hard, outer, pressure-resistant tube having an outside and an inside;

a diffusion layer covering the inside of said outer tube, said diffusion layer being permeable to the substance; and said outer tube having holes formed therein extending from the outside to said diffusion layer.

In other words, the objects of the invention are achieved with an assembly that includes an outer hard pressure-stable tube that is covered, on the inside, by a diffusion layer which is permeable to the substance to be detected, and in that holes which extend from outside as far as the diffusion layer are formed in the outer tube.

The outer hard tube is particularly advantageous when the pump does not suck a transport medium, which is usually air, through the sensor tube, but presses it through the tube, in order to generate excess pressure in the sensor tube. The transport medium and consequently the substance which has penetrated can then be moved over a markedly greater distance than would be possible in the case of suction and a vacuum. Moreover, on account of the outer hard tube, the sensor tube advantageously withstands a high external pressure, such as, for example, the water pressure in the vicinity of an underwater pipeline laid in the ocean.

The term “hard” as used herein refers to a degree of hardness and resilience that is defined by the intended use of the sensor tube. Longer distances between pumping stations and higher exterior pressures will generally require harder material for the tubes.

The substance to be detected in the event of a leakage passes through the holes arranged in the outer tube to the diffusion layer and diffuses through this layer into an inner conduit of the tube. The ambient air or the seawater which surrounds the sensor tube passes through these holes only as far as the edge of the diffusion layer.

The sensor tube according to the invention affords the advantage that the sensor tube can be used over a greater line segment than hitherto and, furthermore, withstands a higher external pressure.

For example, the diffusion layer is located between an inner hard transport tube and the outer tube, holes which extend from inside as far as the diffusion layer being arranged in the transport tube.

This affords the advantage that the diffusion layer is protected from inside. When the transport medium is moved with excess pressure through the conduit of the sensor tube, the diffusion layer cannot be damaged. So that the substance diffusing through the diffusion layer from outside can pass into the inner conduit, holes are arranged in the transport tube.

The transport tube consists, for example, of a material which has only low adsorption. This affords the advantage that the substance located in the transport tube, after arriving there from outside, is not adsorbed or is only slightly adsorbed by the inner wall of the transport tube. This then ensures that the substance arrives essentially completely at the sensor. Other features which are considered as characteristic for the invention are set forth in the appended claims.

Although the invention is illustrated and described herein as embodied in a sensor tube for determining a concentration profile, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a section through a sensor tube formed of an outer hard tube and of an inner diffusion layer; and

FIG. 2 is a section through a sensor tube with an outer hard tube, a diffusion layer, and an inner transport tube.

### DESCRIPTION OF THE PREFERRED EMBODIMENTS

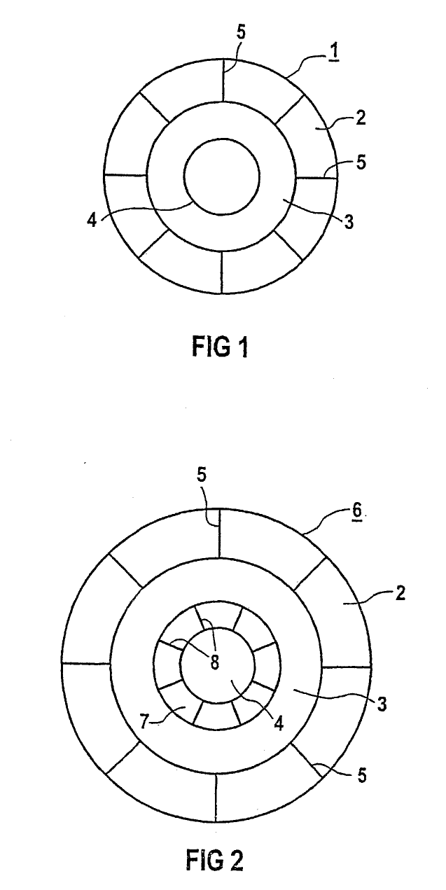

Referring now to the figures of the drawing in detail and first, particularly, to FIG. 1 thereof, there is shown a sensor tube 1 that is configured for a leak detection and location system (LDLS). The tube comprises an outer hard pressure-resistant tube 2 which is covered on the inside by a diffusion layer 3. A conduit 4 remains free within the sensor tube 1. If a substance to be detected, which has emerged, for example, from a leak in a pipeline, arrives at the sensor tube 1 from outside, the substance penetrates through holes 5, which are formed in the outer tube 2 and extend as far as the diffusion layer 3, into the sensor tube 1. The substance then diffuses through the diffusion layer 3 and passes into the conduit 4. After the diffusion phase, a transport medium is pumped through the conduit 4 for a defined timespan and the substance is detected by means of a sensor at the end of the sensor tube 1.

FIG. 2 shows a sensor tube 6 that largely corresponds to the sensor tube 1 of FIG. 1. The only difference is that the diffusion layer 3 is located between an inner hard transport tube 7 and the outer hard tube 2. Holes 8 which extend from inside as far as the diffusion layer 3 are formed in the transport tube 7. The diffusion layer 3 is protected from a high pressure of the transport medium by the inner transport tube 7. The diffused-in substance passes from the diffusion layer 3 out through the bores 8 into the conduit 4. The transport tube 7 consists of a material which has only low adsorption, so that the substance reaches the sensor essentially completely.

I claim:

1. A sensor tube for determining a concentration profile of a substance along a path, comprising:
a hard, outer, pressure-resistant tube having an outside and an inside;
a diffusion layer covering the inside of said outer tube, said diffusion layer being permeable to the substance; and
said outer tube having holes formed therein extending from the outside to said diffusion layer.

2. The sensor tube according to claim 1, which further comprises a hard inner transport tube disposed inside said diffusion layer and said outer tube, said diffusion layer being disposed between said inner transport tube and said outer tube, and said inner transport tube is formed with holes extending from inside to said diffusion layer.

3. The sensor tube according to claim 2, wherein said inner transport tube is formed of a material having only low adsorption.
